(19) United States
(12) Patent Application Publication
(10) Pub. No.: US 2024/0032721 A1
(43) Pub. Date: Feb. 1, 2024

(54) LID OF PRESSURE COOKER AND PRESSURE COOKER USING THE LID

(71) Applicant: Instant Brands Holdings Inc., Downers Grove, IL (US)

(72) Inventor: Jason LePinske, Schaumburg, IL (US)

(73) Assignee: Instant Brands Holdings Inc., Downers Grove, IL (US)

(21) Appl. No.: 18/357,340

(22) Filed: Jul. 24, 2023

Related U.S. Application Data
(60) Provisional application No. 63/392,984, filed on Jul. 28, 2022.

(51) Int. Cl. A47J 27/08; A47J 27/086; A47J 37/06; A47J 36/10; F24C 15/32

(52) U.S. Cl. CPC A47J 27/0808; A47J 27/086; A47J 37/0641; A47J 36/10; F24C 15/325

(57) ABSTRACT

A pressure cooker includes a cooker body and a lid. The lid is positionable above the cooker body and includes a heater, a fan, a motor, one or more protrusions, a tab, and a connector. The heater is configured to provide heat to the cooker body. The fan is configured to provide air flow to the cooker body. The motor is configured to drive the fan. The first protrusions are configured to lock the lid to the cooker body to preserve pressure in the cooker body. The tab is movable between a first position and a second position to engage or disengage the one or more first protrusions with the cooker body by sliding along a predetermine route. The tab is positioned at a side of the one or more first protrusions opposite to a center of the lid. The connector is coupled to the first protrusions and the tab.

### RELATED APPLICATION

This application claims the benefit of U.S. Provisional Application No. 63/392,984, filed on Jul. 28, 2022, pending, the entirety of which is incorporated herein by reference.

### TECHNICAL FIELD

This disclosure relates to a cooker, and more particularly, the lid of the cooker.

### BACKGROUND

Electric cooking appliances, such as electric pressure cookers (EPCs) and air fryers, are commonly used household appliances. The variety of different cooking household appliances occupies much space, so it would be beneficial to have an appliance that can perform different types of cooking.

### BRIEF DESCRIPTION OF THE DRAWINGS

The embodiments disclosed herein can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 shows a perspective view of a pressure cooker with air frying function;

FIG. 2 shows a partial exploded perspective view of the pressure cooker of FIG. 1;

FIG. 3 shows a partial enlarged view of the pressure cooker of FIG. 1;

FIG. 4 shows a partial enlarged view of the pressure cooker of FIG. 1 from another view point;

FIG. 5 shows a cross-sectional view of the top portion of the pressure cooker of FIG. 1;

FIG. 6 shows a vertical cross-sectional view of the pressure cooker of FIG. 1;

FIG. 7 shows an enlarged view of a rear end of the pressure cooker of FIG. 1;

FIG. 8 shows a ring and other components of the lid of FIG. 1;

FIG. 9 illustrates the engagement between the cooker body and the lid;

FIG. 10 illustrates the latch, tab, and the connector of the pressure cooker; and

FIG. 11 is an exploded view of FIG. 10.

### DETAILED DESCRIPTION

While cookers having multiple functions in combination, such as pressure cooking and air frying functions, can be beneficial for their versatility, to include such different functions, the weight of the cooker and/or the cooker lid may be increased significantly.

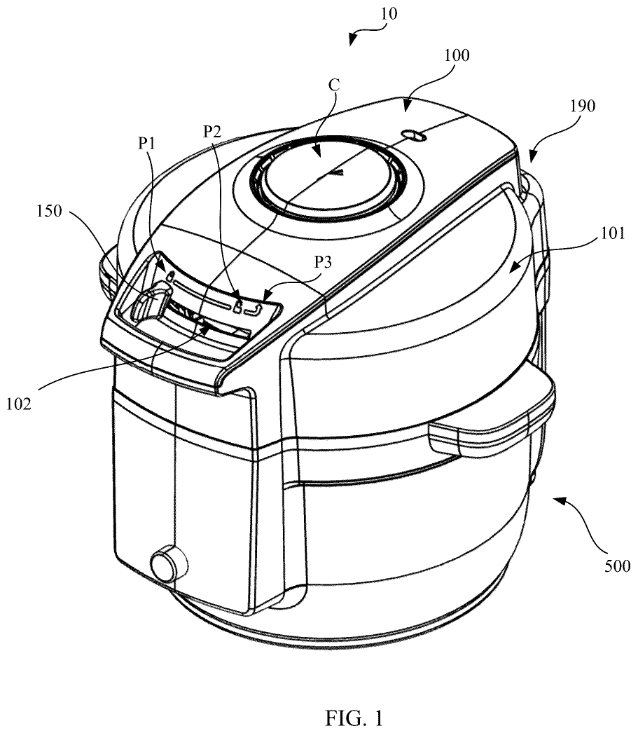

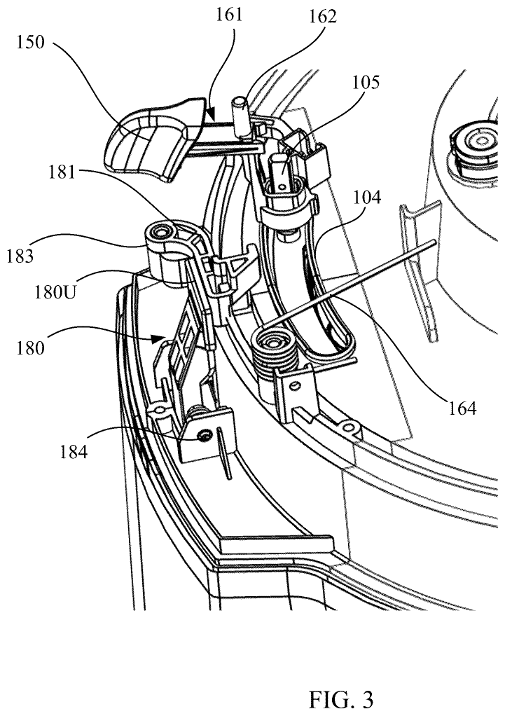

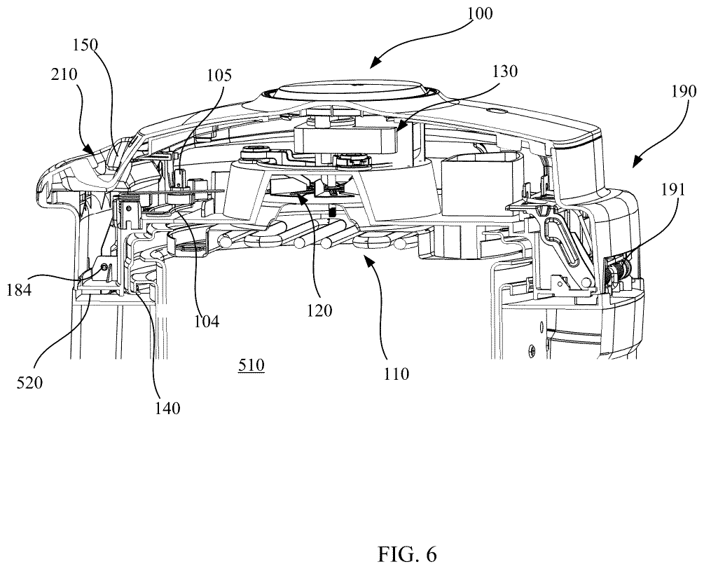

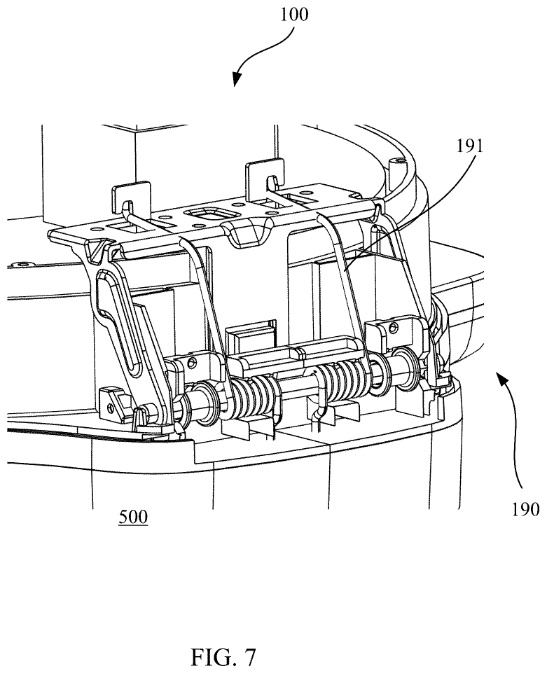

As shown in FIGS. 1-6, the pressure cooker 10 may include a lid 100 and a cooker body 500. The lid 100 may include a heater 110, a fan 120, a motor 130 (as shown in FIG. 6), one or more first protrusions 140, a tab 150, and a connector 160. The lid 100 of the pressure cooker 10 having the components to allow it to perform the functions of a pressure cooker as well as an air fryer, but the components in the lid 100, such as the motor, the first protrusions, the heater, and so on, have added significant weight to the lid 100, which render the lid hard to be opened, or otherwise operated, by a user if there is no corresponding mitigating design.

The lid 100 is positionable above the cooker body 500. The heater 110 is configured to provide heat to the cooker body 500. The fan 120 is proximate the heater, and the fan 120 is configured to generate air flow to a cooking space 510 in the cooker body 500. For example, the air flow may bring the heat produced by the heater 110 to the cooking space 510 to heat the food housed in the cooking space 510. The motor 130 is coupled to and configured to drive the fan 120, such that the fan 120 can provide the air flow. The fan 120 and the heater 110 positioned in the lid 100 may allow the pressure cooker 10 to function as an air fryer.

The one or more first protrusions 140 are configured to engage with the cooker body 500 to lock the lid 100 to the cooker body 500 to preserve pressure in the cooker body 500. When the pressure cooker 10 is working, the first protrusions 140 can provide a solid engagement to prevent the pressure in the pressure cooker 10 from opening the lid 100.

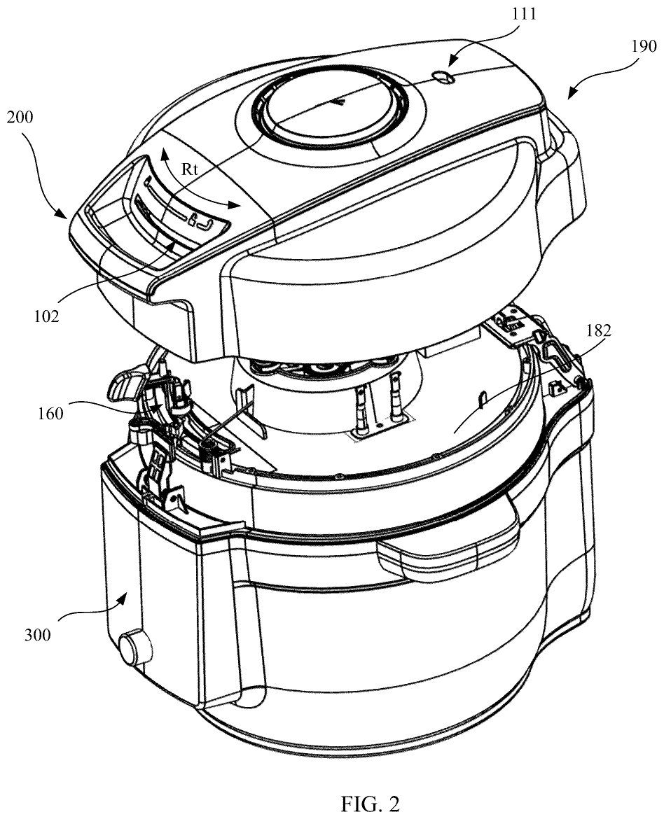

The tab 150 is operably coupled with the first protrusions 140. The coupling can be direct or indirect coupling. The tab 150 is movable between a first position P1 and a second position P2 (as shown in FIG. 1 as an example). A user can slide the tab 150 from the first position P1 to the second position P2 along a predetermined route Rt (as shown in FIG. 2 as an example). As an example, the tab 150 is positioned at a side of the one or more first protrusions 140 opposite to a center C of the lid 100. The center C is a general concept, and it does not mean to define a particular point of the lid 100. The tab 150 is at an outer periphery 101 of the lid 100 as compared to the first protrusions 140, such that a user can apply less force (due to mechanical advantage of a longer leverage) to move the first protrusions 140 to disengage the first protrusions 140 with the cooker body 500 if the use intends to open the lid 100.

The lid 100 may further include a connector 160. The connector 160 may be positioned inside the lid 100. The connector 160 may be coupled to the first protrusions 140 at one location and coupled to the tab 150 at another location. For example, the connector 160 may include a first arm 161, and the first arm 161 may extend through an external facing first slot 102 to be coupled to the tab 150. With the connector 160 extending between the first protrusions 140 and the tab 150, a movement by the user of the tab 150 can move the first protrusions 140 toward another position. As an example, the first slot 102 may be curved and follow the curvature of the periphery of the lid 100.

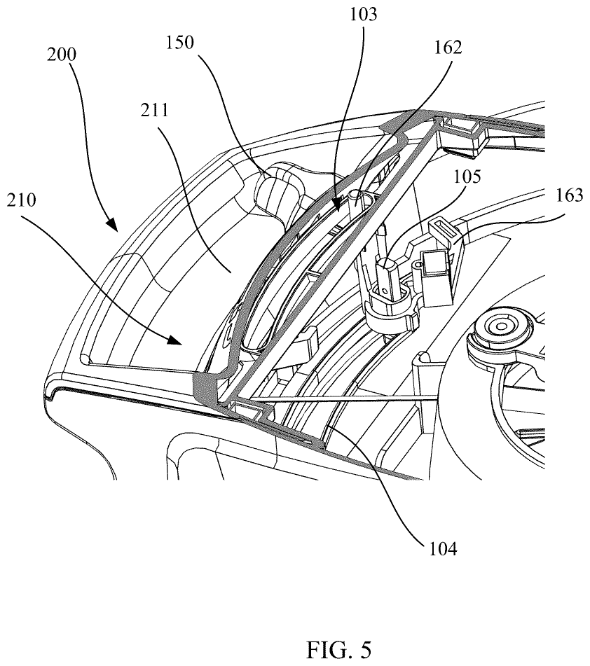

In one embodiment, the connector 160 may further include a second arm 162. The second arm 162 may extend upwardly (e.g., away from the cooker body 500) through a second slot 103 (as shown in FIG. 5, for example). The second slot 103 may be positioned above the first arm 161, and the second slot 103 may be contoured with the first slot 102, so that they can both guide the movement of the connector 160. The second arm 162 can be guided by the second slot 103. The second arm 162 may move along the second slot 103 when the tab is moved from a first position P1 to a second position P2 (and then to a third position P3 as shown in FIG. 1). The first slot 102 and the second slot 103 may be concentric. The first arm 161 and the second arm 162 of the connector 160 may be of a unitary construction, such as made by a same piece of plastic material from a modeling process.

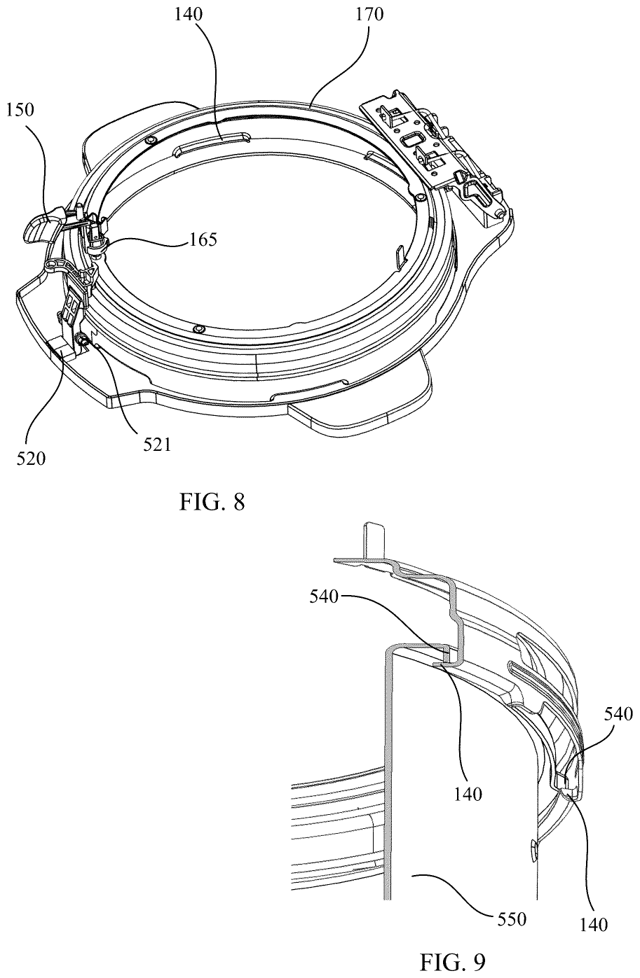

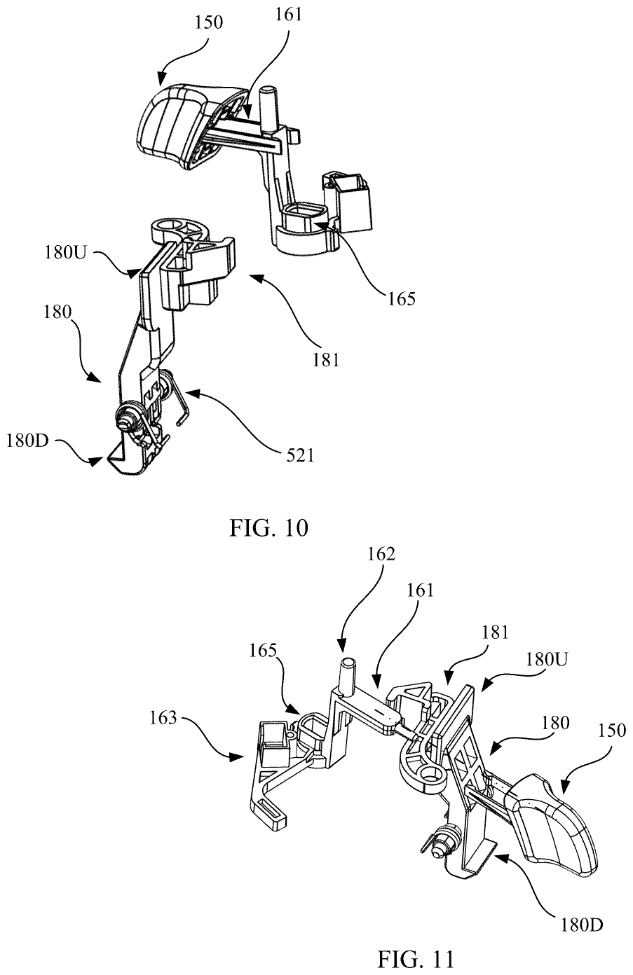

As an example, the lid 100 may further include a ring 170 (as shown in FIG. 8 as an example). The ring 170 may be circular. The one or more first protrusions 140 may be formed on an inner periphery of the ring 170, and the first protrusions may extend inwardly. The first protrusions 140 may be evenly distributed around the inner periphery. The lid 100 may further include a third arm 105, and the third arm 105 may be operably coupled to the connector 160 at one position and operably coupled to the ring 170 at another position, such that the tab 150 can move the ring 170 (as well as the first protrusions 140) via the connector 160. For example, the third arm 105 may extend through a third slot 104 contoured with the first slot 102. The third slot 104 may be located at a lower position than the first slot 102.

Correspondingly, the cooker body 500 may include one or more second protrusions 540 (as shown in FIG. 9 as an example) to be engaged with the first protrusions 140. The second protrusions 540 may be positioned at a periphery of a pot 550 of the cooker body 500. The second protrusions 540 may be evenly distributed along the periphery. When the first protrusions 140 and the second protrusions 540 are disengaged, the first protrusions 140 and the second protrusions 540 is not aligned with each other. When the first protrusions 140 and the second protrusions 540 are engaged, the first protrusions 140 and the second protrusions 540 overlap (at least partially) with each other. The movement of the tab 150 may rotate the first protrusions 140, so as to remove the overlap.

As an example, the third arm 105 may be coupled with the connector 160 via a loop 165 of the connector 160 surrounding the third arm 105. The third arm 105 may be inserted into the loop 165. The third arm 105 may be made of different material from the connector 160. For example, the third arm 105 can be made of metal like the ring 170 of the lid 100, and the third arm 105 may be welded with the ring 170.

After the tab 150 moves from the first position P1 to the second position P2, the first protrusions 140 may be disengaged with the cooker body 500. But, the lid 100 may not be opened at this time because a latch 180 may be engaged with the cooker body 500 by having a hook shaped lower end inserted into a concave 520 of the cooker body 500. The tab 150 can be moved further to a third position P3. This movement can further disengage the latch 180 with the cooker body 500, such that the lid 100 can be opened, for example, by a biasing force. Further, the lid 100 may be biased to be pop opened once the latch 180 is released.

In one embodiment, the connector 160 may further include a fourth arm 163 extending in a direction opposite the second position P2. For example, when the connector 160 is positioned at the first position P1, the fourth arm 163 extends opposite to the predetermined route Rt defined by the first slot 102. The fourth arm 163 may move along with the movement of the connector 160 caused by a user's operation on the tab 150. The latch 180 is movable between an engaged position where the latch 180 is engaged with the cooker body 500 at the concave 520 and a disengaged position where the latch 180 is not engaged with the cooker body 500. The fourth arm 163 may be configured to move the latch 180 from the engaged position to the disengaged position when the tab 150 is moved from the second position P2 to the third position P3, to allow a biasing force to at least partially open the lid 100.

In one embodiment, the lid 100 may further include a base 182, which defines the third slot 104. The lid 100 may include a cantilever 181 connected to the base 182 at a hinge 183. The fourth arm 163 may be configured to engage the cantilever 181 when the tab 150 is moved from the second position P2 to the third position P3, such that the cantilever 181 is pushed to pivot about the first hinge 183, to eventually touch the upper portion 180U of the latch 180, and to move the latch 180 from the engaged position to the disengaged position.

In one embodiment, the latch 180 may pivot about a hinge 184 and is biased by a spring 521. Therefore, when the cantilever 181 engages the latch 180, the upper end 180U of the latch 180 moves forward and away from the center of the lid 100; the lower end 180D of the latch 180 moves backward toward the center C of the lid 100. The lower end 180D of the latch 180 may thereby be disengaged with the concave 520 of the cooker body 500, which received the lower end 180D of the latch 180. The spring 521 may bias the latch 180 to maintain the latch 180 at the engaged position. The spring 521 can be a compression spring, an extension spring, a conical spring, a torsion spring, a laminated or leaf spring, or a disc or belleville spring, or other type of elastic component.

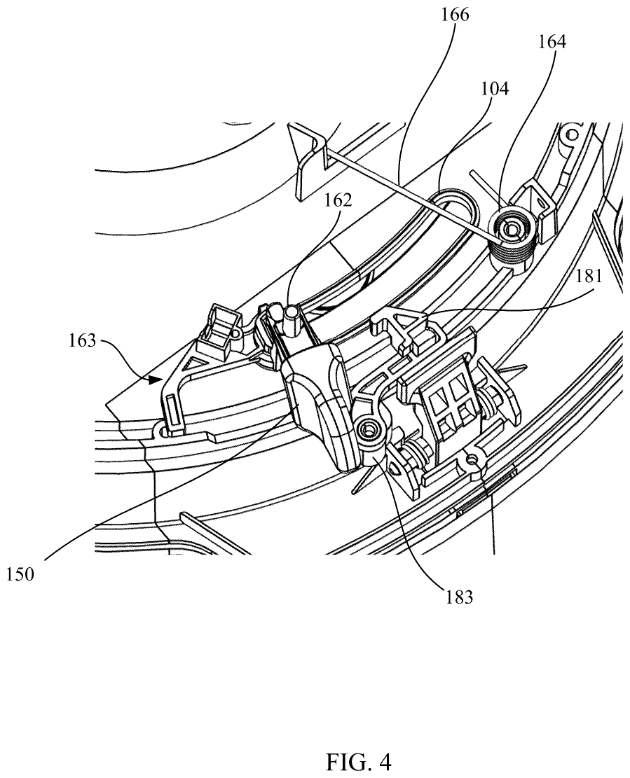

According to one embodiment, the lid 100 may further include an elastic stopper 164 configured to bias the connector 160 or the third arm 105 toward the second position P2 when the connector moves between the second position P2 and the third position P3. For example, the elastic stopper 164 may push the connector 160 or tab 150 backward from the third position P3 to the second position P2, such that the cantilever 181 can move backward and that the latch 180 can be moved back to the engaged position based on the biasing force from the spring 521. As an example. the elastic stopper 164 may include a spring extending over the third slot 104. The elastic stopper 164 may include a compression spring, an extension spring, a conical spring, a torsion spring, a laminated or leaf spring, or a disc or belleville spring, or other type of elastic components. As shown in FIG. 4, the elastic stopper 164 may include an extending arm 166 of an end of a torsion spring. The extending arm 166 extends over the third slot 104. When the connector 160 moves proximate to the end of the third slot 104, the connector 160 may contact the extending arm 166. Due to the torsion spring, the extending arm 166 may provide a force to push the connector 160 back toward to the second position P2.

Additionally, in one exemplary embodiment, the lid 100 may be biased toward an open position. For example, the lid 100 may be biased by an elastic component, such as a spring, positioned at a periphery of the cooker body 500 opposite the tab 150. The biasing force may come from an elastic component 191 located at a hinge 190 about which the lid 100 pivots. The lid 100 may couple with the cooker body 500 at the hinge 190. The hinge 190 may be positioned at an opposite side of the cooker body 500 from the tab. Because the lid 100 is biased, the lid 100 may be pop opened once the first protrusions 140 are first disengaged with the cooker body 500 (when the tab 150 arrives the second position P2) and then the latch 180 is positioned at the disengaged position (when the tab further moves toward the third position P3 from the second position P2).

The biasing force of the lid 100 may help the lid 100 to be opened. The lid 100 of this disclosure may include a motor, a fan, a heater, and other component for pressure cooking, air frying, or other cooking functions, and therefore, the lid 100 may be heavier than a lid of a traditional pressure cooker. The biasing force helps a user open the lid 100. The tab 150 helps the user to easily disengage the first protrusions 140 and the latch 180 at a predefined sequence. The tab 150 positioned at an outer periphery of the pressure cooker allows a user to use less force (due to mechanical advantage of using a longer leverage), and the connection between the first protrusions 140 and the tab 150 allows the first protrusions 140 to move the same radial distance as the tab 150 (as opposed to some fraction thereof), such that a user can move the first protrusions 140 without much unnecessarily movement.

In one exemplary embodiment, the pressure cooker 10 may include a handle 200. The handle 200 may extend outwardly from the lid 100 adjacent the first slot 102. The handle may be positioned directly above a control panel 300 of the pressure cooker 10. The handles 200 may extend outward from the control panel 300. The handle 200 may form a trench 210, such as a closed trench 210. The tab 150 may be movable within the trench 210. The trench 210 may have side walls enclosing the trench's 210 periphery, which may provide protection to the fingers of a user when the user is operating the tab 150. The handle 200 may define an outermost periphery at a side of the lid 100 opposite to the hinge 190 connecting the lid 100 to the cooker body 500. The first slot 102 can be formed on an inner side wall of the handle 200. The inner side wall may be forward facing to a user.

According to an exemplary embodiment, the tab 150 may be positioned at a location between the valve 111 and the cooker body 500 along a vertical axis. For example, the tab 150 may be positioned at a lower position than the location of the pressure releasing valve 111. The valve 111 is used to release the pressure in the pressure cooker, and may be located at the top of the lid 100. If a user wants to open the pressure cooker 10 safely, the pressure may need to be released first. The valve 111 can provide a rapid way to release the pressure in the cooker body 500, but however, if the pressure kept in the pressure cooker 10 is still very high, the progress of releasing the pressure can be frightening due to the amount of the releasing steam. Having a tab 150 at a lower position (and preferably and optionally in an closed trench), may provide a longer distance between the tab 150 and the pressure-releasing valve 111. The positioned and configuration may also let a user feel protective. Correspondingly, the handle 200 may be positioned at a lower position than the valve 111 such that the tab 150 can move within the closed trench 210. For example, the closed trench 210 may have a bottom wall 211 as shown in FIG. 5. The bottom wall 211 separates the user's figure operating the tab 150 from the opening between the lid 100 and the cooker body 500 when the lid is pop opened. The handle 200 therefore may protect the user's figures from the heat coming out from the opening at the time the lid 100 is opened.

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

One skilled in the art will realize that a virtually unlimited number of variations to the above descriptions are possible, and that the examples and the accompanying figures are merely to illustrate one or more examples of implementations.

It will be understood by those skilled in the art that various other modifications can be made, and equivalents can be substituted, without departing from claimed subject matter. Additionally, many modifications can be made to adapt a particular situation to the teachings of claimed subject matter without departing from the central concept described herein. Therefore, it is intended that claimed subject matter not be limited to the particular embodiments disclosed, but that such claimed subject matter can also include all embodiments falling within the scope of the appended claims, and equivalents thereof.

In the detailed description above, numerous specific details are set forth to provide a thorough understanding of claimed subject matter. However, it will be understood by those skilled in the art that claimed subject matter can be practiced without these specific details. In other instances, methods, devices, or systems that would be known by one of ordinary skill have not been described in detail so as not to obscure claimed subject matter.

Reference throughout this specification to “one embodiment,” “an embodiment,” “one aspect,” or “an aspect” can mean that a particular feature, structure, or characteristic described in connection with a particular embodiment can be included in at least one embodiment of claimed subject matter. Thus, appearances of the phrase “in one embodiment,” “an embodiment,” “in on aspect,” or “an aspect,” in various places throughout this specification are not necessarily intended to refer to the same embodiment or to any one particular embodiment described. Furthermore, it is to be understood that particular features, structures, or characteristics described can be combined in various ways in one or more embodiments. In general, of course, these and other issues can vary with the particular context of usage. Therefore, the particular context of the description or the usage of these terms can provide helpful guidance regarding inferences to be drawn for that context.

What is claimed is:

1. A pressure cooker, comprising:
a cooker body; and
a lid, positionable above the cooker body, comprising:
a heater configured to provide heat to the cooker body;
a fan proximate the heater and configured to provide air flow to the cooker body;
a motor coupled to and configured to drive the fan;
one or more first protrusions configured to engage with the cooker body to lock the lid to the cooker body to preserve pressure in the cooker body;
a tab operably coupled with the one or more first protrusions and movable between a first position and a second position to engage or disengage the one or more first protrusions with the cooker body by sliding along a predetermine route, wherein the tab is positioned at a side of the one or more first protrusions opposite to a center of the lid; and
a connector positioned inside the lid and coupled to the one or more first protrusions and the tab, the connector comprising a first arm extending through an external facing first slot.

2. The pressure cooker of claim 1, wherein the connector further comprises a second arm extending upwardly through a second slot above the first arm, the second slot being contoured with the first slot, and wherein the first slot and the second slot are concentric.

3. The pressure cooker of claim 2, wherein the lid further comprises a ring on which the one or more first protrusions are formed, the lid comprising a third arm operably coupled to the connector and the ring, wherein the third arm extends through a third slot contoured with the first slot.

4. The pressure cooker of claim 3, wherein the connector further comprises a fourth arm extending in a direction opposite the second position, the lid further comprising a latch movable between an engaged position where the latch is engaged with the cooker body and a disengaged position where the latch is not engaged with the cooker body, the fourth arm being configured to move the latch from the engaged position to the disengaged position, to allow a biasing force to at least partially open the lid, after the tab is moved to disengage the one or more first protrusions with the cooker body.

5. The pressure cooker of claim 4, wherein the lid further comprises a base defining the third slot, and a cantilever connected to the base at a first hinge, the fourth arm being configured to engage the cantilever, such that the cantilever pivots about the first hinge to move the latch from the engaged position to the disengaged position.

6. The pressure cooker of claim 5, wherein the latch pivots about a second hinge and is biased by a spring for maintaining the engaged position.

7. The pressure cooker of claim 1, wherein the tab is movable between the second position and a third position, and the tab is biased toward the second position when it moves from the second position to the third position.

8. The pressure cooker of claim 7, wherein the lid further comprises a spring configured to bias the connector toward the second position when the tab moves from the second position to the third position.

9. The pressure cooker of claim 8, wherein the lid is biased toward an open position when the tab is moved to disengage the one or more first protrusions in the lid from the cooker body.

10. The pressure cooker of claim 9, wherein the lid is biased by a spring positioned at a periphery of the cooker body opposite the tab.

11. The pressure cooker of claim 10, wherein the lid further comprises a handle extending outwardly from the lid adjacent the first slot to form a closed trench, the tab being movable within the trench.

12. A pressure cooker comprising:
a cooker body; and
a lid, positionable above the cooker body, comprising:
a heater configured to provide heat to the cooker body;
a fan adjacent to the heater and configured to provide air flow to the cooker body;
a motor, coupled to the fan and configured to drive the fan;
one or more first protrusions, configured to engage with the cooker body to lock the cooker body and the lid to preserve pressure in the cooker body;
a valve configured to release pressure in the cooker body;
a tab operably coupled with the one or more first protrusions and movable to engage or disengage the one or more first protrusions with the cooker body by sliding along a predetermine route; and
a handle, extending outwardly to form a periphery of the lid at a side opposite to a hinge about which the lid pivots, the handle comprising a closed trench in which the tab is movable.

13. The pressure cooker of claim 12, wherein the handle defines an outermost periphery of the lid opposite to the hinge.

14. The pressure cooker of claim 12, wherein the tab is movable along a first slot positioned at a forward-facing sidewall located above the handle.

15. The pressure cooker of claim 12, wherein the hinge including a biasing element to open the lid.

16. The pressure cooker of claim 12 wherein the tab is movable from a first position to a second position and the tab is configured to disengage the one or more first protrusions with the cooker body when it arrives the second position.

17. The pressure cooker of claim 16, wherein the tab is movable from the second position to a third position and the tab is configured to disengage a latch of the lid from the cooker body when the tab moves from the second position to the third position.

18. A pressure cooker, comprising:
a cooker body; and
a lid, positionable above the cooker body and comprising:
a heater, configured to provide heart to the cooker body;
a fan, adjacent to the heater and configured to provide air flow to the cooker body;
a motor, coupled to the fan and configured to drive the fan;
one or more first protrusions, configured to engage with the cooker body to lock the cooker body and the lid to preserve pressure in the cooker body;
a latch, coupled to the lid and the cooker body and configure to prevent a biasing force from opening the lid; and
a tab, operably coupled with the one or more first protrusions and movable from a first position, when the one or more protrusions are engaged with the cooker body, to a second position, when the one or more protrusions are disengaged with the cooker body, and then to a third position, when the latch is moved from an engaged position with the cooker body to a disengaged position.

19. The pressure cooker of claim 18, wherein the lid is configured to move under the biasing force to a partially opened position after the latch is disengaged by the movement of the tab from the second position toward the third position.

20. The pressure cooker of claim 18, wherein the lid further comprises a handle extending outwardly to form a periphery of the lid at a side opposite to a hinge about which the lid pivots, the handle comprising a closed trench in which the tab is movable.
